(19) United States
(12) Patent Application Publication
(10) Pub. No.: US 2026/0289540 A1
(43) Pub. Date: Sep. 24, 2026

(54) ITEM INFORMATION PROVIDING SYSTEM, ITEM INFORMATION PROVIDING METHOD, AND NON-TRANSITORY COMPUTER-READABLE MEDIUM FOR PROVIDING ITEM INFORMATION

(71) Applicant: GLORY LTD., Himeji-shi (JP)

(72) Inventor: Yuki FUJIHISA, Himeji-shi (JP)

(73) Assignee: GLORY LTD., Himeji-shi (JP)

(21) Appl. No.: 19/564,263

(22) Filed: Mar. 12, 2026

(30) Foreign Application Priority Data
Mar. 19, 2025 (JP) 2025-045394

(51) Int. Cl. G06Q 20/20; G06Q 30/0207; G06V 20/52; G06V 40/16; G06V 40/20

(52) U.S. Cl. CPC G06Q 20/208; G06Q 30/0222; G06V 20/52; G06V 40/168; G06V 40/20

(57) ABSTRACT

A camera at the ceiling of a store captures a customer. From the captured video, the position of the customer is determined, and customer specifying data including this position information and gender, clothes, etc. of the customer is generated and notified to an information processing apparatus. The information processing apparatus stores the customer specifying data and specifies information on an item that the customer was viewing. From video captured by a camera of the store, an information display apparatus generates viewer specifying data including gender, clothes, etc., of a customer and notifies the information processing apparatus. Upon determination of presence of the same person in the viewer specifying data and the customer specifying data, the information processing apparatus notifies the information display apparatus of item benefit information. The information display apparatus displays the item benefit information.

### CROSS-REFERENCE TO RELATED APPLICATION

The present application is a continuation of, and claims priority to, Japanese patent application JP 2025-045394 filed Mar. 19, 2025, the entire contents of which is incorporated herein by reference.

### TECHNICAL FIELD

The present disclosure relates to an item information providing system, an item information providing method, and a non-transitory computer-readable medium for providing item information that can enhance a customer's willingness to purchase an item, based on the behavior of the customer moving around in a store.

### BACKGROUND ART

Conventionally, it has been known that advertisement distribution personalized for customers enhances the advertisement effect. Therefore, a conventional technology in which, also in an actual store in which items are sold, various behaviors of a customer are detected, and based on the detected behaviors, an advertisement according to the preference of the customer is distributed, is known.

For example, WO2024/013777 discloses a shopping support system that supports shopping activities of a customer by displaying an item arrangement shelf on a dome-shaped display, analyzing an image obtained by capturing a behavior such as a customer reaching for an item, and displaying items in which the customer may be interested, on an aerial display.

Japanese Laid-Open Patent Publication No. 2021-168169 discloses a digital signage for stores in which motion of a person present in a predetermined range in front of a display screen is detected by a camera, a weight sensor, a contact sensor, an acceleration sensor, an infrared sensor, or the like, and a promotion video of a specific item according to the detected motion of the person is displayed on the display screen.

However, the conventional art may not be efficient because, when a behavior of a customer is to be detected in a plurality of areas, it is necessary to install an advertisement medium near each area, which causes excessively high introduction costs of the system. In a store, there is a need to analyze various behaviors of a customer moving around in the store, and to provide sales promotion information that evokes purchase willingness of the customer, by means of an advertisement medium. However, conventional art may not cope with such a need.

### SUMMARY

The present disclosure has been made in view of the problem, as well as other problems, of the conventional art, and the present disclosure addresses these issues, as discussed herein, with an item information providing system, an item information providing method, and a non-transitory computer-readable medium for providing item information that can enhance a customer's willingness to purchase an item, based on the behavior of the customer moving around in a store.

An item information providing system according to one aspect of the present disclosure includes: a first acquisition unit configured to acquire information on a behavior of a customer at a first location and customer specifying information capable of identifying the customer; a specifying unit configured to specify an item in which the customer is interested, based on the behavior of the customer acquired by the first acquisition unit; a second acquisition unit configured to acquire customer specifying information of a customer being at a second location; and a display control circuitry configured to, when the customer specifying information acquired by the first acquisition unit and the customer specifying information acquired by the second acquisition unit match each other as a result of collation therebetween, perform control to display, on a display apparatus, information on the item in which the customer is interested.

### BRIEF DESCRIPTION OF THE DRAWINGS

FIG. 1A and FIG. 1B illustrate the outline of an item information providing system according to Embodiment 1;

FIG. 2 shows the system configuration of the item information providing system according to Embodiment 1;

FIG. 3 is a function block diagram showing the configuration of a camera shown in FIG. 2;

FIG. 4 is a function block diagram showing the configuration of an information display apparatus shown in FIG. 2;

FIG. 5 shows an example of item benefit data shown in FIG. 4;

FIG. 6 is a function block diagram showing the configuration of an information processing apparatus shown in FIG. 2;

FIGS. 7A and 7B show examples of item management data and item shelf data shown in FIG. 6;

FIGS. 8A to 8C show examples of customer specifying data, item specifying data, and viewer specifying data shown in FIG. 6;

FIG. 9 is a flowchart showing the processing procedure performed in the information processing apparatus according to Embodiment 1;

FIG. 10 shows an example of a hardware configuration regarding the information processing apparatus according to Embodiment 1;

FIG. 11 is an illustration (No. 1) of the outline of an item information providing system according to Embodiment 2; and

FIG. 12 is an illustration (No. 2) of the outline of the item information providing system according to Embodiment 2.

### DESCRIPTION OF EMBODIMENTS

### Embodiment 1

Hereinafter, an embodiment of an item information providing system, an item information providing method, and a non-transitory computer-readable medium for providing item information will be described in detail with reference to the drawings.

### <Outline of Item Information Providing System According to Embodiment 1>

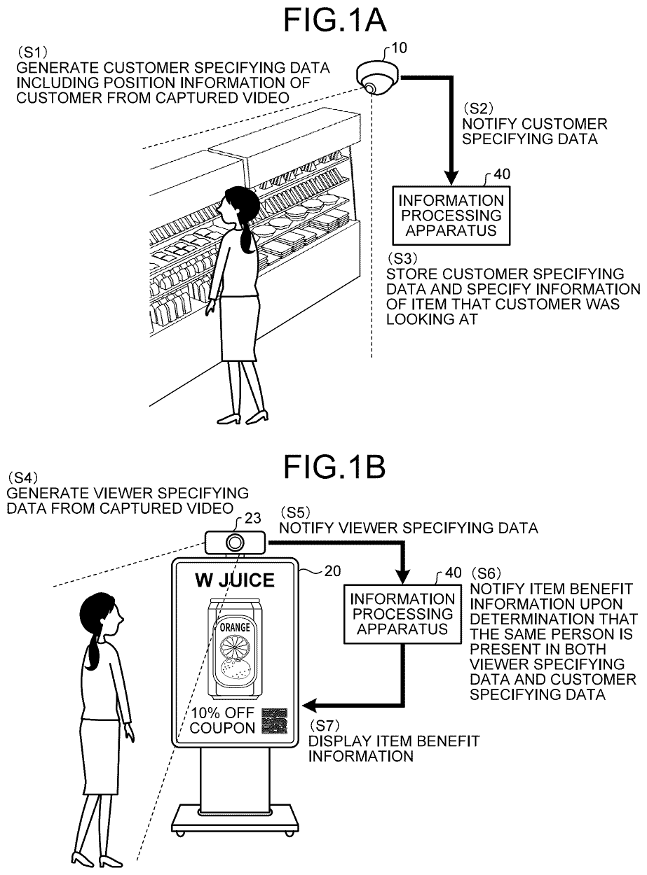

First, the outline of the item information providing system according to Embodiment 1 will be described. FIG. 1A and FIG. 1B illustrate the outline of the item information providing system according to Embodiment 1.

As shown in FIG. 1A, in the item information providing system, a camera 10 installed at the ceiling or the like of a store captures a customer, the position of the customer is determined from this captured video, and customer specifying data including this position information, the gender, clothes, and the like of the customer is generated (S1).

The camera 10 notifies an information processing apparatus 40 of the customer specifying data (S2). The information processing apparatus 40 stores the received customer specifying data and specifies information on the item that the customer was looking at (S3).

As shown in FIG. 1B, an information display apparatus 20 generates viewer specifying data including the gender, clothes, and the like of a customer from a video captured by a camera 23 (S4), and notifies the information processing apparatus 40 of this viewer specifying data (S5). That is, the customer specifying data is obtained using the first camera 10 at a first location, while the viewer specifying data is obtained using the second camera 23 at a second location different from the first location. The customer specifying data and the viewer specifying data may be used as customer specifying information for specifying a customer.

When it has been determined that the person specified by the viewer specifying data is the same person as that specified by the customer specifying data, the information processing apparatus 40 notifies the information display apparatus 20 of item benefit information for the item that the customer was looking at(S6). The information display apparatus 20 displays the received item benefit information (S7).

In the item information providing system according to Embodiment 1, the information processing apparatus 40 acquires information on an item and information on a customer who is looking at the item. The information may be acquired for each customer in the store, and stored in and managed by the information processing apparatus 40. The information processing apparatus 40 also acquires information on a customer near the information display apparatus and determines whether this customer is one of the customers who were looking at items. If the customer near the information display apparatus is the same customer who was looking at the item, the information processing apparatus 40 displays benefit information for the item that this customer was looking at, on the information display apparatus. Accordingly, based on the behavior of the customer moving around in the store, the customer's willingness to purchase an item can be enhanced.

### <System Configuration of Item Information Providing System According to Embodiment 1>

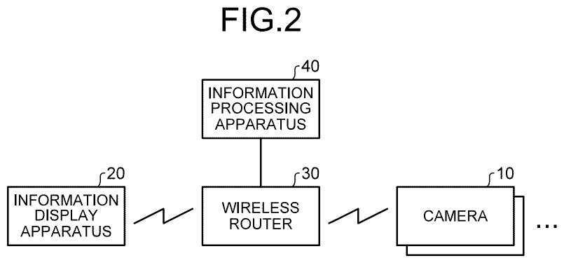

Next, the system configuration of the item information providing system according to Embodiment 1 will be described. FIG. 2 shows the system configuration of the item information providing system according to Embodiment 1.

As shown in FIG. 2, the information processing apparatus 40 installed in the store is communicably connected to the camera 10 and the information display apparatus 20 via a wireless router 30. The wireless router 30 may be connected to the camera 10 and the information display apparatus 20 through short-range wireless communication, such as wireless LAN communication.

The camera 10 is an imaging device installed at the ceiling or the like in the store so as to be able to capture a customer near an item shelf. The camera 10 stores, as video data, a video captured from when the customer has entered the imaging range to when the customer has moved out of the imaging range.

The camera 10 estimates the attribute of the customer appearing in the video data, and generates a person ID for uniquely identifying each customer in the video data. Then, the camera 10 determines the position of the customer, associates the customer attribute and the customer position with the person ID, and transmits the resultant information to the information processing apparatus 40 as customer specifying data.

The information display apparatus 20 is a display device such as a digital signage installed in the store in order to display an item advertisement and the like. The information display apparatus 20 stores, as video data, a video captured from when a customer has entered the imaging range of an attached camera to when the customer has moved out of the imaging range.

The information display apparatus 20 estimates the attribute of the customer appearing in the video data, generates a person ID for uniquely identifying each customer in the video data. The information display apparatus 20 associates the attribute with the person ID, and transmits the resultant information to the information processing apparatus 40 as viewer specifying data.

When having received item benefit data from the information processing apparatus 40, the information display apparatus 20 displays this item benefit data for a predetermined time (e.g., for one minute). At this time, a two-dimensional barcode, such as a QR code (registered trademark), indicating a URL of a coupon which is a benefit for the item is additionally displayed.

The information processing apparatus 40 is an apparatus that performs display control of benefit information for items. When having received data regarding an item, the information processing apparatus 40 stores the received data into item management data. When having received arrangement information of items for each item shelf, the information processing apparatus 40 stores the received arrangement information of the items for each item shelf into item shelf data.

When having received customer specifying data from the camera 10, the information processing apparatus 40 stores the received data and extracts the person ID and the customer position from this stored data. Then, the information processing apparatus 40 specifies the item number corresponding to this customer position based on the item shelf data, and stores the item number in association with the person ID, into item specifying data.

When having received viewer specifying data from the information display apparatus 20, the information processing apparatus 40 stores the received viewer specifying data, compares the customer attribute of this stored viewer specifying data with the customer attribute of the customer specifying data, and determines whether or not the same person is present. That is, it is determined whether the person specified based on the viewer specifying data is the same person as a customer whose customer specifying data has been acquired. When the same person has been determined to be present in the customers looking at items, the item number corresponding to this customer is specified from the item specifying data. Then, the item name, the benefit, and the URL corresponding to the specified item number are extracted from the item management data and are transmitted to the information display apparatus 20 as item benefit data.

### <Configuration of Camera 10>

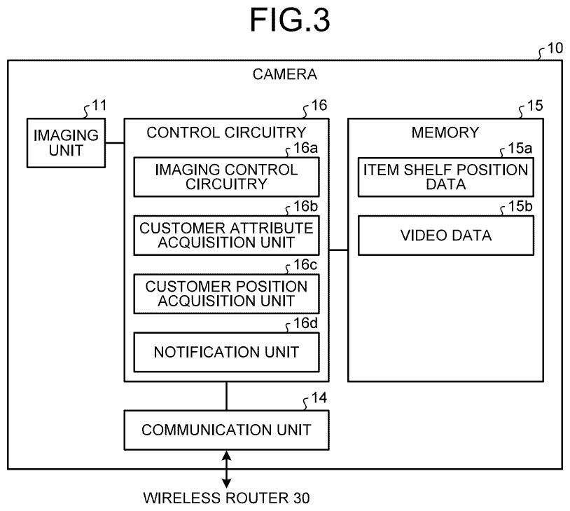

Next, the configuration of the camera 10 shown in FIG. 2 will be described. FIG. 3 is a function block diagram showing the configuration of the camera 10 shown in FIG. 2. As shown in FIG. 3, the camera 10 includes an imaging unit 11, a communication unit 14, a memory 15, and a control circuitry 16.

The imaging unit 11 is an imaging device that captures customers. The communication unit 14 is an interface unit for performing data communication with the information processing apparatus 40 via the wireless router 30.

The memory 15 is a storage device such as a nonvolatile memory, and stores therein item shelf position data 15a and video data 15b. The item shelf position data 15a is data indicating the position and the item shelf number of the item shelf appearing in the video captured by the imaging unit 11. The video data 15b is data indicating the video of each customer captured by the imaging unit 11.

The control circuitry 16 performs overall control of the camera 10, and includes an imaging control circuitry 16a, a customer attribute acquisition unit 16b, a customer position acquisition unit 16c, and a notification unit 16d. In actuality, programs corresponding to these units are loaded onto a CPU (Central Processing Unit) and executed, whereby processes respectively corresponding to the imaging control circuitry 16a, the customer attribute acquisition unit 16b, the customer position acquisition unit 16c, and the notification unit 16d are performed.

The imaging control circuitry 16a is a processing unit that controls the imaging unit 11 and manages the video data 15b. The imaging control circuitry 16a stores the video captured by the imaging unit 11 into the video data 15b. When the memory capacity capable of storing the video data 15b has run out, the data is overwritten starting from the oldest data and stored.

The customer attribute acquisition unit 16b is a processing unit that acquires the attribute of the customer appearing in the video data 15b. When the video data 15b has been updated by the imaging control circuitry 16a, the customer attribute acquisition unit 16b estimates the attribute of the customer appearing in the video data 15b and generates a unique person ID.

The attribute may denote the gender, colors of clothes, and the like. A learned model trained by machine learning for estimating attributes of a person may be used to perform the attribute estimation. The learned model may estimate information on the gender, the colors and/or shapes of upper and/or lower clothes, a hat, and shoes, and belongings such as a bag, based on visual features of the person appearing in the video.

The customer position acquisition unit 16c is a processing unit that acquires position information of the customer appearing in the video data 15b. When the video data 15b has been updated by the imaging control circuitry 16a, the customer position acquisition unit 16c determines the position of the customer appearing in the video data 15b, by using the item shelf position data 15a. For example, when the position of the customer is near the center of an item shelf having an item shelf number “2101”, the item shelf number “2101” and a shelf position “middle shelf” are determined as the customer position. The determination of the position of the customer is performed only when the customer has stopped in front of an item shelf for a predetermined time (e.g., for one second) or more.

The notification unit 16d is a processing unit that notifies customer specifying data. When the attribute of the customer has been estimated by the customer attribute acquisition unit 16b, a person ID has been generated, and the customer position has been determined by the customer position acquisition unit 16c, the notification unit 16d associates the customer attribute and the customer position with this person ID, and transmits the resultant information to the information processing apparatus 40 as customer specifying data.

### <Configuration of Information Display Apparatus 20>

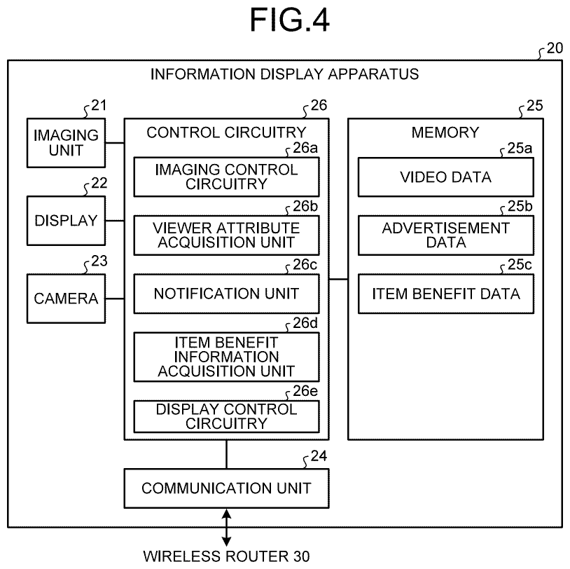

Next, the configuration of the information display apparatus 20 shown in FIG. 2 will be described. FIG. 4 is a function block diagram showing the configuration of the information display apparatus 20 shown in FIG. 2. As shown in FIG. 4, the information display apparatus 20 includes an imaging unit 21, a display 22, the camera 23, a communication unit 24, a memory 25, and a control circuitry 26.

The imaging unit 21 is an imaging device that captures customers. The display 22 is a display device such as a liquid crystal panel that displays advertisement images. The camera 23 is an imaging device that captures customers. The communication unit 24 is an interface unit for performing data communication with the information processing apparatus 40 via the wireless router 30.

The memory 25 is a storage device such as a hard disk device or a nonvolatile memory, and stores therein video data 25a, advertisement data 25b, and item benefit data 25c. The video data 25a is data indicating the video of each customer captured by the imaging unit 21. The advertisement data 25b is data indicating an advertisement image to be displayed on the display 22, and includes a program guide related to this advertisement image. The item benefit data 25c is data indicating an item benefit image to be displayed on the display 22.

The control circuitry 26 performs overall control of the information display apparatus 20, and includes an imaging control circuitry 26a, a viewer attribute acquisition unit 26b, a notification unit 26c, an item benefit information acquisition unit 26d, and a display control circuitry 26e. In actuality, programs corresponding to these units are loaded onto a CPU and executed, whereby processes respectively corresponding to the imaging control circuitry 26a, the viewer attribute acquisition unit 26b, the notification unit 26c, the item benefit information acquisition unit 26d, and the display control circuitry 26e are performed.

The imaging control circuitry 26a is a processing unit that controls the imaging unit 21 and that manages the video data 25a. The imaging control circuitry 26a stores the video captured by the imaging unit 21 into the video data 25a. When the memory capacity capable of storing the video data 25a has run out, the data is overwritten starting from the oldest data and stored.

The viewer attribute acquisition unit 26b is a processing unit that acquires the attribute of the customer appearing in the video data 25a. When the video data 25a has been updated by the imaging control circuitry 26a, the viewer attribute acquisition unit 26b estimates the attribute of the customer appearing in the video data 25a and generates a unique person ID.

The notification unit 26c is a processing unit that notifies viewer specifying data. When the attribute of the customer has been estimated by the viewer attribute acquisition unit 26b and a person ID has been generated, the notification unit 26c associates the customer attribute with this person ID and transmits the resultant information to the information processing apparatus 40 as viewer specifying data. The notification of the viewer specifying data is performed from the stage where the customer attribute has first been detected. Accordingly, while the customer is viewing the information display apparatus 20, the information processing apparatus 40 determines whether or not the same person as the viewer is present with reference to the customer specifying data, and when such a person is present, benefit information is quickly displayed on the information display apparatus 20, whereby the benefit information can be displayed while the customer is viewing the information display apparatus 20.

The item benefit information acquisition unit 26d is a processing unit that acquires item benefit data and manages the item benefit data 25c. When having received item benefit data from the information processing apparatus 40, the item benefit information acquisition unit 26d stores the received data into the item benefit data 25c.

The display control circuitry 26e is a processing unit that performs display control of advertisement images and item benefit images. The display control circuitry 26e displays an advertisement image on the display 22, based on the program guide of the advertisement data 25b. When the item benefit data 25c has been updated by the item benefit information acquisition unit 26d, the display control circuitry 26e displays this item benefit data 25c for a predetermined time (e.g., for one minute) on the display 22. At this time, a QR code (registered trademark) indicating a URL related to a coupon which is a benefit for the item is displayed.

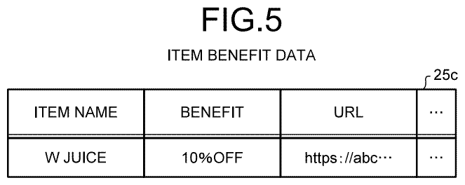

Next, an example of data stored in the memory 25 of the information display apparatus 20 shown in FIG. 4 will be described. FIG. 5 shows an example of the item benefit data 25c shown in FIG. 4.

In the item benefit data 25c shown in FIG. 5, item name “W juice”, benefit “10% OFF ”, and URL “https://abc . . . ” are associated with each other.

### <Configuration of Information Processing Apparatus 40>

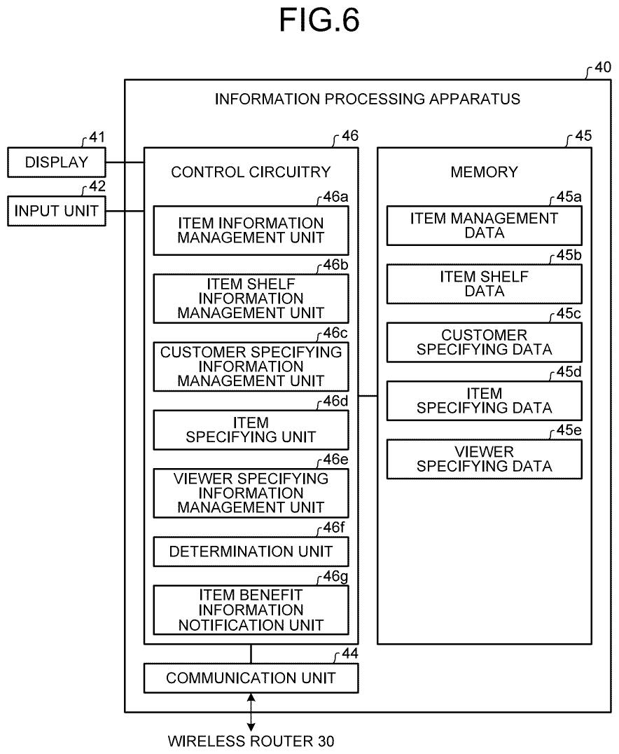

Next, the configuration of the information processing apparatus 40 shown in FIG. 2 will be described. FIG. 6 is a function block diagram showing the configuration of the information processing apparatus 40 shown in FIG. 2. As shown in FIG. 6, the information processing apparatus 40 is connected to a display 41 and an input unit 42 and includes a communication unit 44, a memory 45, and a control circuitry 46.

The display 41 is a display device such as a liquid crystal panel display. The input unit 42 is an input device such as a keyboard or a mouse. The communication unit 44 is an interface unit for performing data communication with the camera 10 and the information display apparatus 20 via the wireless router 30.

The memory 45 is a storage device such as a hard disk device or a nonvolatile memory, and stores therein item management data 45a, item shelf data 45b, customer specifying data 45c, item specifying data 45d, and viewer specifying data 45e.

The item management data 45a is data indicating information on items, and includes data regarding benefits for the items. The item shelf data 45b indicates data including item numbers of items arranged on each item shelf. The item shelf data 45b may include planogram information.

The customer specifying data 45c is data indicating information on customers captured by the camera 10. The item specifying data 45d is data indicating items that the customers captured by the camera 10 were looking at. The viewer specifying data 45e is data indicating information on the customer captured by the information display apparatus 20.

The control circuitry 46 performs overall control of the information processing apparatus 40, and includes an item information management unit 46a, an item shelf information management unit 46b, a customer specifying information management unit 46c, an item specifying unit 46d, a viewer specifying information management unit 46e, a determination unit 46f, and an item benefit information notification unit 46g. In actuality, programs corresponding to these units are loaded onto a CPU and executed, whereby processes respectively corresponding to the item information management unit 46a, the item shelf information management unit 46b, the customer specifying information management unit 46c, the item specifying unit 46d, the viewer specifying information management unit 46e, the determination unit 46f, and the item benefit information notification unit 46g are performed.

The item information management unit 46a is a processing unit that manages the item management data 45a. When having received data regarding an item from the input unit 42, the item information management unit 46a stores the received data into the item management data 45a.

The item shelf information management unit 46b is a processing unit that manages the item shelf data 45b. When having received arrangement information of items for each item shelf from the input unit 42, the item shelf information management unit 46b stores the received arrangement information of items for each item shelf, into the item shelf data 45b. The arrangement information of items includes item numbers for each of up-down and left-right shelf sections of the item shelf. For example, the up-down shelf section is sectioned into an upper tier, a middle tier, and a lower tier, and the left-right shelf section is sectioned into a left shelf, a middle shelf, and a right shelf.

The customer specifying information management unit 46c is a processing unit that manages the customer specifying data 45c. When having received customer specifying data from the camera 10, the customer specifying information management unit 46c stores the received data into the customer specifying data 45c.

The item specifying unit 46d is a processing unit that specifies an item that the customer whose information is stored in the customer specifying data 45c was looking at. When the customer specifying data 45c has been updated by the customer specifying information management unit 46c, the item specifying unit 46d extracts the person ID and the customer position of this updated data. Then, the item number corresponding to this customer position is specified from the item shelf data 45b and is associated with the person ID, and the resultant information is stored into the item specifying data 45d.

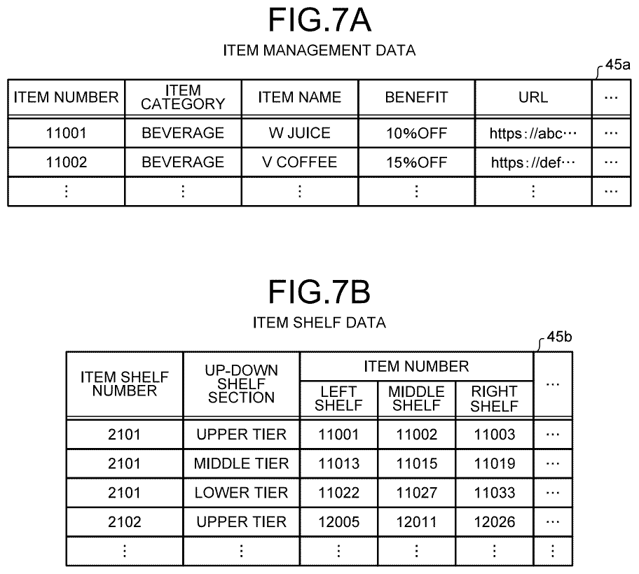

For example, when the extracted customer position corresponds to an item shelf number “2101” and a shelf position “middle shelf”, an upper tier “11002”, a middle tier “11015”, and a lower tier “11027” corresponding to the middle shelf of the item shelf number “2101” are specified (see FIG. 7B). When the customer position is determined in the camera 10, the posture (standing, half-crouching, etc.) of the customer may be determined, and from this posture, the up-down shelf section (upper tier, middle tier, or lower tier) that the customer is looking at may be determined. When this up-down shelf section can be made clear, a single item number is specified.

The viewer specifying information management unit 46e is a processing unit that manages the viewer specifying data 45e. When having received viewer specifying data from the information display apparatus 20, the viewer specifying information management unit 46e stores the received data into the viewer specifying data 45e.

The determination unit 46f is a processing unit that determines whether or not the same person as the customer whose information is stored in the viewer specifying data 45e is present among the customers whose information is stored in the customer specifying data 45c. When the viewer specifying data 45e has been updated by the viewer specifying information management unit 46e, the determination unit 46f compares the customer attribute in this updated viewer specifying data with the customer attribute in the customer specifying data stored in the customer specifying data 45c, and determines whether or not the same person is present. In this determination, it may be determined that the same person is present, only when all the attributes match each other, or it may be determined that the same person is present, when a predetermined matching ratio (e.g., 80%) or more is satisfied.

The item benefit information notification unit 46g is a processing unit that transmits item benefit data when it has been determined that the same person is present by the determination unit 46f. Upon determination of the presence of the same person by the determination unit 46f, the item benefit information notification unit 46g specifies, from the item specifying data 45d, the item number corresponding to the person ID in the customer specifying data 45c. Then, information on the item name, the benefit, and the URL corresponding to the specified item number are extracted from the item management data 45a, and are transmitted to the information display apparatus 20 as item benefit data.

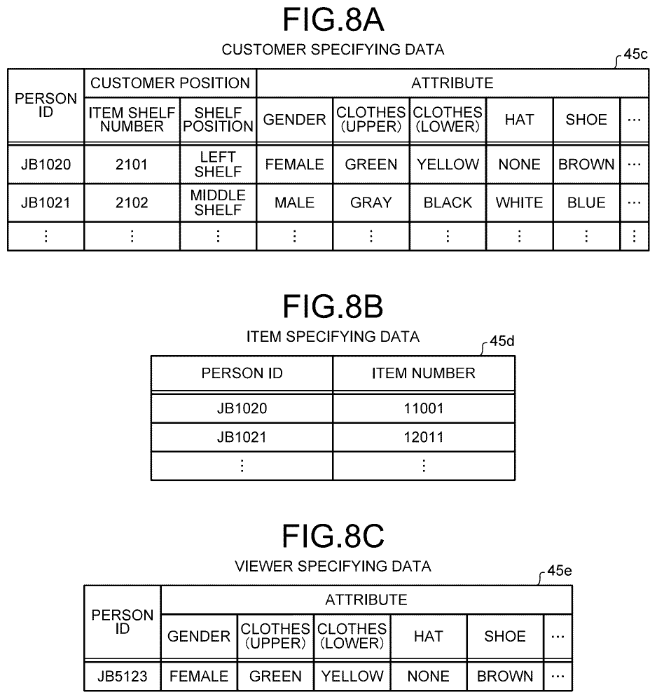

Next, an example of data stored in the memory 45 of the information processing apparatus 40 shown in FIG. 6 will be described. FIGS. 7A and 7B and FIGS. 8A to 8C show examples of the item management data 45a, the item shelf data 45b, the customer specifying data 45c, the item specifying data 45d, and the viewer specifying data 45e shown in FIG. 6.

In the item management data 45a shown in FIG. 7A, item number “11001” is associated with item category “beverage”, item name “W juice”, benefit “10% OFF ”, and URL “https://abc . . . ”, and item number “11002” is associated with item category “beverage”, item name “V coffee”, benefit “15% OFF”, and URL “https://def. . . ”.

In the item shelf data 45b shown in FIG. 7B, item shelf number “2101” and up-down shelf section “upper tier” are associated with item number “11001” in left shelf, item number “11002” in middle shelf, and item number “11003” in right shelf, and item shelf number “2101” and up-down shelf section “middle tier” are associated with item number “11013” in left shelf, item number “11015” in middle shelf, and item number “11019” in right shelf.

In addition, in the item shelf data 45b, item shelf number “2101” and up-down shelf section “lower tier” are associated with item number “11022” in left shelf, item number “11027” in middle shelf, and item number “11033” in right shelf, and item shelf number “2102” and up-down shelf section “upper tier” are associated with item number “12005” in left shelf, item number “12011” in middle shelf, and item number “12026” in right shelf.

In the customer specifying data 45c shown in FIG. 8A, person ID “JB1020” is associated with item shelf number “2101” and shelf position “left shelf” in customer position, and gender “female”, clothes (upper) “green”, clothes (lower) “yellow”, hat “none”, and shoes “brown” in attribute.

In addition, in the customer specifying data 45c, person ID “JB1021” is associated with item shelf number “2102” and shelf position “middle shelf” in customer position, and gender “male”, clothes (upper) “gray”, clothes (lower) “black”, hat “white”, and shoes “blue” in attribute.

In the item specifying data 45d shown in FIG. 8B, person ID “JB1020” is associated with item number “11001”, and person ID “JB1021” is associated with item number “12011”.

In the viewer specifying data 45e shown in FIG. 8C, person ID “JB5123” is associated with gender “female”, clothes (upper) “green”, clothes (lower) “yellow”, hat “none”, and shoes “brown” in attribute.

### <Processing Procedure Performed in Information Processing Apparatus 40 According to Embodiment 1>

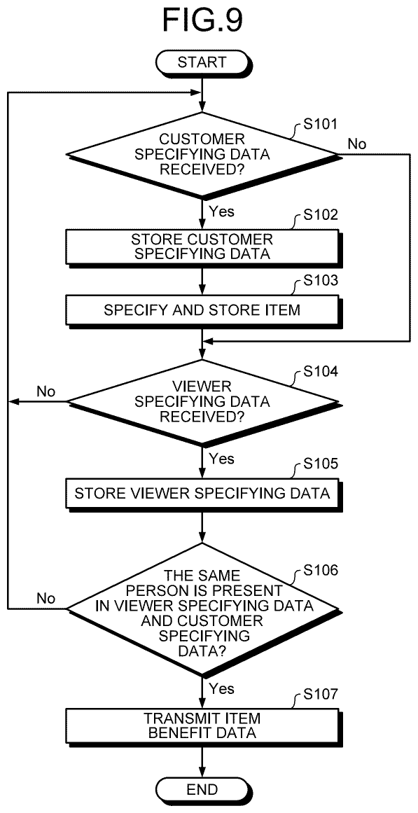

Next, the processing procedure performed in the information processing apparatus 40 according to Embodiment 1 will be described. FIG. 9 is a flowchart showing the processing procedure performed in the information processing apparatus 40 according to Embodiment 1.

As shown in FIG. 9, when customer specifying data has not been received from the camera 10 (step S101: No), the information processing apparatus 40 shifts to step S104, and when customer specifying data has been received from the camera 10 (step S101: Yes), the information processing apparatus 40 stores the received data into the customer specifying data 45c (step S102).

The person ID and the customer position of the customer specifying data 45c are extracted, and the item number corresponding to this customer position is specified from the item shelf data 45b, and is stored in association with the person ID into the item specifying data 45d (step S103).

When viewer specifying data has not been received from the information display apparatus 20 (step S104: No), the process returns to step S101, and when viewer specifying data has been received (step S104: Yes), the received data is stored into the viewer specifying data 45e (step S105).

Whether or not the same person as the customer stored in the viewer specifying data 45e is present among the customers stored in the customer specifying data 45c is determined, and when the same person is not present (step S106: No), the process returns to step S101.

When it has been determined that the same person is present (step S106: Yes), the item that this customer was looking at, is specified from the item specifying data 45d. Then, information on the benefit for this item is extracted from the item management data 45a and transmitted to the information display apparatus 20 as item benefit data (step S107), and the process ends.

### <Example Of Hardware Configuration Regarding Information Processing Apparatus 40 According to Embodiment 1>

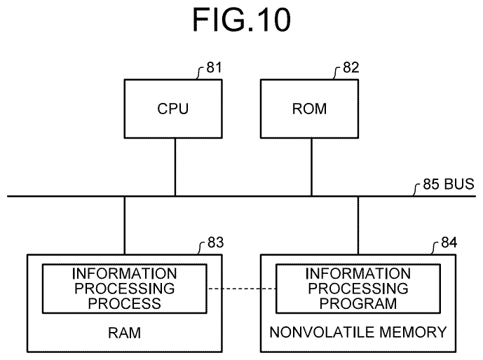

Next, correspondence between the information processing apparatus 40 according to Embodiment 1 and a major hardware configuration of a computer will be described. FIG. 10 shows an example of a hardware configuration regarding the information processing apparatus 40 according to Embodiment 1.

In general, a computer has a configuration in which a CPU 81, a ROM 82, a RAM 83, and a nonvolatile memory 84 are connected to each other by a bus 85. A hard disk device may be provided instead of the nonvolatile memory 84. For convenience of description, only a basic hardware configuration is shown.

Here, a program and the like necessary for activation of an operating system (hereinafter, simply referred to as “OS”) are stored in the ROM 82 and the nonvolatile memory 84. When power is supplied, the CPU 81 reads the program for the OS from the ROM 82 or the nonvolatile memory 84 and executes the program.

Meanwhile, various application programs to be executed on the OS are stored in the nonvolatile memory 84. The CPU 81 executes an application program while using the RAM 83 as a main memory, whereby the process corresponding to the application is performed.

An information processing program for the information processing apparatus 40 according to Embodiment 1 is also stored in the nonvolatile memory 84 or the like, as in the case of the other application programs, and the CPU 81 loads and executes the program. In the case of the information processing apparatus 40 according to Embodiment 1, an information processing program that includes routines corresponding to the item information management unit 46a, the item shelf information management unit 46b, the customer specifying information management unit 46c, the item specifying unit 46d, the viewer specifying information management unit 46e, the determination unit 46f, and the item benefit information notification unit 46g shown in FIG. 6 is stored in the nonvolatile memory 84 or the like. The information processing program is loaded and executed by the CPU 81, whereby an information processing process corresponding to the item information management unit 46a, the item shelf information management unit 46b, the customer specifying information management unit 46c, the item specifying unit 46d, the viewer specifying information management unit 46e, the determination unit 46f, and the item benefit information notification unit 46g is generated.

As described above, in the item information providing system according to Embodiment 1, information on each customer in the store and information on an item that each customer is looking at are acquired and stored in the apparatus. Based on the acquired information, when it has been determined that the same person as the customer near the information display apparatus is present among the customers who were looking at items, benefit information for the item that this customer was looking at is displayed on the information display apparatus. Therefore, based on the behavior of the customer moving around in the store, the customer's willingness to purchase an item can be enhanced.

Although, in Embodiment 1 above, information on an item in the store and a customer looking at the item is acquired, and when the same person as the customer near the information display apparatus has been determined to be present among the customers who were looking at items, benefit information for the item that this customer was looking at is displayed on the information display apparatus, the present disclosure is not limited thereto. Even when the same person as the customer near the information display apparatus has been determined to be present among the customers who were looking at items, if this customer has already put this item into a shopping basket or has already purchased this item, the benefit information for the item may not necessarily be displayed on the information display apparatus. Specifically, while an item held in a hand of the customer is specified through an object recognition process, if a motion of the customer putting the item held in the hand into a basket has been detected through skeleton estimation, it is determined that the customer has put the item into the shopping basket. Alternatively, using a captured image of a shopping basket used by the customer, an object recognition process of recognizing the label, shape, or the like of the item is performed, and then, the recognition result is compared with an item master data, whereby the item put into the shopping basket may be specified. In addition, when a POS terminal is connected to a camera, POS data obtained using the POS terminal is associated with the attribute information of the purchaser obtained using the camera and then, these pieces of information are transmitted to an information processing apparatus in real time, whereby the fact that the customer has purchased the item may be specified. Meanwhile, when the POS terminal is not connected to a camera, the POS terminal and the camera individually transmit POS data and the attribute information of the purchaser to the information processing apparatus, and based on the time at which the item was purchased and the time at which the purchaser was captured, the information processing apparatus associates the POS data and the attribute information of the purchaser, thereby specifying that the customer has purchased the item. Then, when it has been specified that the customer has purchased the item in which the customer was interested, benefit information is controlled so as not to be displayed.

In Embodiment 1, information on clothes and belongings is used as the attribute of the customer, but the present disclosure is not limited thereto. As the attribute of the customer, the age, the gender, and the walking pattern may be acquired to be used as the attribute of the customer.

In Embodiment 1, as the behavior indicating that the customer is interested in an item, a behavior in which the customer is looking at an item placed on an item shelf is used, but the present disclosure is not limited thereto. It may be determined that the customer is interested in an item when the customer takes the item in a hand, touches the item, reaches for an item shelf, stays for a certain time in front of an item shelf, stops in front of an item shelf a plurality of times, or turns the face toward the item.

In Embodiment 1, from the relationship between the position of the customer and the item shelf, the item in which the customer is interested is specified, but the present disclosure is not limited thereto. The item or the like that the customer has taken in a hand can also be specified through object recognition using an AI camera. In addition, a shelf number, marks of left and right positions, or the like may be attached to a top plate portion of the item shelf, and the item may be specified by recognizing the shelf number or marks by using a camera. A small camera may be installed on the item shelf, and the item may be specified from the line of sight of the customer captured by this camera. Even when the item cannot be specified, an advertisement related to the item category of items place on the shelf where the customer has stopped may be displayed on the information display apparatus.

In Embodiment 1, as the benefit information for the item, a two-dimensional barcode for obtaining a coupon is displayed, but the present disclosure is not limited thereto. The benefit may be given by using other codes including characters and/or numerals. Instead of or in addition to the information of benefit on the item, effective information for recommending the item and/or information on comparison between the item and a similar item may be displayed on the information display apparatus.

In the information providing system, the ratio of displaying benefit information such as the code for obtaining the benefit, the ratio of the customer viewing the displayed benefit information, the ratio of the customer returning to the corresponding selling area after viewing, and the ratio of the customer purchasing the corresponding item after viewing may also be analyzed. Each ration may be calculated based on a predetermined reference. For example, determination of the customer having returned to the corresponding selling area after viewing is made based on the fact that the customer having viewed the item displayed on the information display apparatus has been detected by a selling-area camera that captures the place where this item is arranged, and the ratio is calculated based on the number of customers returned to the selling area and the number of customers who have viewed information on the item displayed on the information display apparatus.

In Embodiment 1, benefit information for the item in which the customer is interested is displayed, but the present disclosure is not limited thereto. When there are a plurality of items in which the customer is interested, one or a plurality of pieces of sales promotion information selected based on a predetermined condition may be displayed. Holding the item in a hand for a designated time or more, or stopping in front of the corresponding item shelf for a designated time or more may be used as the predetermined condition.

In Embodiment 1, the attribute including the gender, the colors of clothes, hat, shoes, and the like is used as the customer specifying data. However, the present disclosure is not limited thereto. From a captured image of the customer, a facial feature amount of the customer may be acquired, and this facial feature amount may be used for the customer specifying data. The facial feature amount may be an expression of the eye positions, nose shape, and the like of a person as numerical data.

### Embodiment 2

In Embodiment 1, using specifying information of each customer acquired from video data obtained by capturing the customer, whether or not the same person as the customer who has come near the information display apparatus is present among the customers who were looking at items is determined. However, the present disclosure is not limited thereto.

Using the identification information of a mobile terminal owned by a customer, whether or not the customer who has come near the information display apparatus is the same person as the customer who was looking at the item may be determined, and benefit information for the item that the customer was looking at may be displayed on the information display apparatus.

In Embodiment 2, an item information providing system in which, using the identification information of a mobile terminal owned by a customer, whether or not the customer who has come near the information display apparatus is the same person as the customer who was looking at item is determined, and benefit information for the item that the customer was looking at is displayed on the information display apparatus, will be described.

### <Outline of Item Information Providing System According to Embodiment 2>

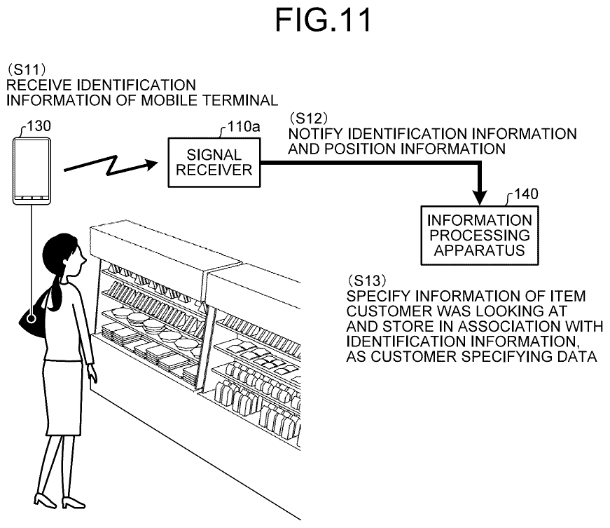

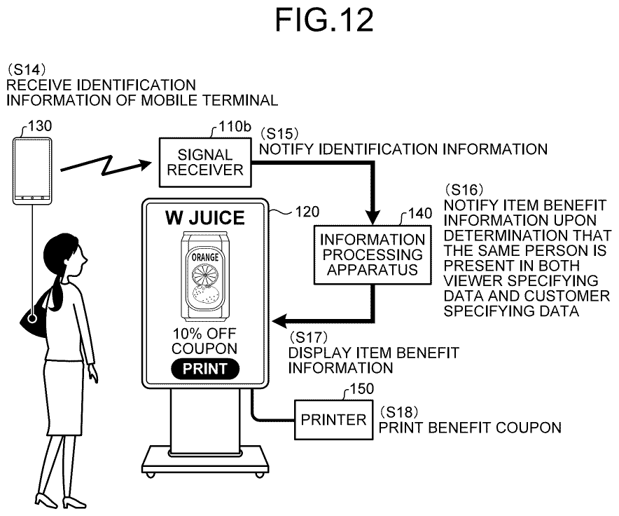

The outline of the item information providing system according to Embodiment 2 will be described. FIG. 11 and FIG. 12 illustrate the outline of the item information providing system according to Embodiment 2.

As shown in FIG. 11, in the item information providing system according to Embodiment 2, identification information transmitted by a mobile terminal 130 owned by a customer is received by a signal receiver 110a installed in the store (S11), and based on the reception direction and the intensity of the received signal, position information of the mobile terminal 130 is calculated. Then, the received identification information and the position information are notified to an information processing apparatus 140 (S12).

Using the received position information, the information processing apparatus 140 specifies information of the item that the customer was looking at, and stores the item information, as customer specifying data, in association with the identification information (S13).

As shown in FIG. 12, identification information transmitted by a mobile terminal 130 owned by a customer is received by a signal receiver 110b installed near an information display apparatus 120 (S14), and the received identification information is notified to the information processing apparatus 140 (S15).

When the received identification information is the same as that of the customer specifying data, the information processing apparatus 140 notifies the information display apparatus 120 of item benefit information according to item information of the customer specifying data (S16).

The information display apparatus 120 displays the received item benefit information (S17). At this time, a printing button may be additionally displayed with the benefit information. When the printing button has been operated by the customer, a benefit coupon is printed from a printer 150 (S18). The printer 150 may be provided near or included in the information display apparatus 120.

As described above, in the item information providing system according to Embodiment 2, using the identification information of the mobile terminal owned by the customer, whether or not the customer who has come near the information display apparatus is the same person as the customer who was looking at the item is determined, and benefit information for the item that the customer was looking at is displayed on the information display apparatus. Therefore, based on the behavior of the customer moving around in the store, the customer's willingness to purchase an item can be enhanced.

An item information providing system according to one embodiment of the present disclosure includes: a first acquisition unit configured to acquire information on a behavior of a customer at a first location and customer specifying information capable of identifying the customer; a specifying unit configured to specify an item in which the customer is interested, based on the behavior of the customer acquired by the first acquisition unit; a second acquisition unit configured to acquire customer specifying information of a customer being at a second location; and a display control circuitry configured to, when the customer specifying information acquired by the first acquisition unit and the customer specifying information acquired by the second acquisition unit match each other as a result of collation therebetween, perform control of displaying, on a display apparatus, information on the item in which the customer is interested.

In the above configuration, the customer specifying information included a facial feature amount extracted from a face image obtained by capturing a face portion of the customer and/or identification information that uniquely identifies a terminal owned by the customer.

In the above configuration, the display control circuitry performs control to display, on the display apparatus, benefit information usable when the customer purchases the item in which the customer is interested, as the information on the item.

In the above configuration, the benefit information is code information readable by a terminal owned by the customer and/or a predetermined employee terminal.

In the above configuration, the item information providing system further includes a printing control circuitry configured to perform control to print, on a printer, the benefit information.

In the above configuration, an item arranged on an item shelf provided at the first location is specified as the item in which the customer is interested.

An item information providing method according to one embodiment of the present disclosure includes: a first acquisition step of acquiring information on a behavior of a customer at a first location and customer specifying information capable of identifying the customer; a specifying step of specifying an item in which the customer is interested, based on the behavior of the customer acquired in the first acquisition step; a second acquisition step of acquiring customer specifying information of a customer being at a second location; and a display control step of, when the customer specifying information acquired in the first acquisition step and the customer specifying information acquired in the second acquisition step match each other as a result of collation therebetween, performing control of displaying, on a display apparatus, information on the item in which the customer is interested.

A non-transitory computer-readable medium according to one embodiment of the present disclosure, which is used for providing item information, stores instructions that, when executed by a computer, cause the computer to execute: a first acquisition step of acquiring information on a behavior of a customer at a first location and customer specifying information capable of identifying the customer; a specifying step of specifying an item in which the customer is interested, based on the behavior of the customer acquired in the first acquisition step; a second acquisition step of acquiring customer specifying information of a customer being at a second location; and a display control step of, when the customer specifying information acquired in the first acquisition step and the customer specifying information acquired in the second acquisition step match each other as a result of collation therebetween, performing control of displaying, on a display apparatus, information on the item in which the customer is interested.

The illustrated components in each embodiment above are conceptually functional constituent elements, and thus may not necessarily be configured as physical constituent elements, as illustrated in the drawings. That is, distributed or integrated forms of each device are not limited to the forms illustrated in the drawings, and all or some of the forms may be distributed or integrated functionally or physically in any unit depending on various loads, use statuses, or the like.

The item information providing system, the item information providing method, and the item information providing program according to the present disclosure are suitable for enhancing customer's willingness to purchase an item, based on the behavior of the customer moving around in the store.

What is claimed is:

1. An item information providing system comprising:
a first acquisition unit configured to acquire information on a behavior of a customer at a first location and customer specifying information capable of identifying the customer;
a specifying unit configured to specify an item in which the customer is interested, based on the behavior of the customer acquired by the first acquisition unit;
a second acquisition unit configured to acquire customer specifying information of a customer being at a second location; and
a display control circuitry configured to, when the customer specifying information acquired by the first acquisition unit and the customer specifying information acquired by the second acquisition unit match each other as a result of collation therebetween, perform control to display, on a display apparatus, information on the item in which the customer is interested.

2. The item information providing system according to claim 1, wherein
the customer specifying information includes a facial feature amount extracted from a face image obtained by capturing a face portion of the customer and/or identification information that uniquely identifies a terminal owned by the customer.

3. The item information providing system according to claim 1, wherein
the display control circuitry performs control to display, on the display apparatus, benefit information usable when the customer purchases the item in which the customer is interested, as the information on the item.

4. The item information providing system according to claim 3, wherein
the benefit information is code information readable by a terminal owned by the customer and/or a predetermined employee terminal.

5. The item information providing system according to claim 3, further comprising
a printing control circuitry configured to perform control to print, on a printer, the benefit information.

6. The item information providing system according to claim 1, wherein an item arranged on an item shelf provided at the first location is specified as the item in which the customer is interested.

7. An item information providing method comprising:
acquiring information on a behavior of a customer at a first location and first customer specifying information capable of identifying the customer;
specifying an item in which the customer is interested, based on the behavior of the customer acquired in the acquiring;
acquiring second customer specifying information of a customer being at a second location; and
perform, when the first customer specifying information and the second customer specifying information match each other as a result of collation therebetween, control to display, on a display apparatus, information on the item in which the customer is interested.

8. A non-transitory computer-readable medium storing instructions that, when executed by a computer, cause the computer to execute:
acquiring information on a behavior of a customer at a first location and first customer specifying information capable of identifying the customer;
specifying an item in which the customer is interested, based on the behavior of the customer acquired in the acquiring;
acquiring second customer specifying information of a customer being at a second location; and
perform, when the first customer specifying information and the second customer specifying information match each other as a result of collation therebetween, control to display, on a display apparatus, information on the item in which the customer is interested.
